(19) United States
(12) Patent Application Publication
(10) Pub. No.: US 2026/0079808 A1
(43) Pub. Date: Mar. 19, 2026

(54) METHOD FOR OPERATING A QUANTUM COMPUTING SYSTEM AND A QUANTUM COMPUTING SYSTEM

(71) Applicants: HYUNDAI MOTOR COMPANY, Seoul (KR); Kia Corporation, Seoul (KR); UIF (University Industry Foundation), Yonsei University, Seoul (KR)

(72) Inventors: Kyujin SHIN, Hwaseong-si (KR); Donghwi KIM, Hwaseong-si (KR); Woomin KYOUNG, Hwaseong-si (KR); Won Woo RO, Seoul (KR); Enhyeok JANG, Seoul (KR); Seungwoo CHOI, Seoul (KR); Youngmin KIM, Seoul (KR)

(73) Assignees: HYUNDAI MOTOR COMPANY, Seoul (KR); Kia Corporation, Seoul (KR); UIF (University Industry Foundation), Yonsei University, Seoul (KR)

(21) Appl. No.: 18/966,013

(22) Filed: Dec. 2, 2024

(30) Foreign Application Priority Data
Sep. 13, 2024 (KR) 10-2024-0125804

(51) Int. Cl. G06F 11/34; G06F 11/30; G06N 10/20

(52) U.S. Cl. CPC G06F 11/3409; G06F 11/3024; G06N 10/20

(57) ABSTRACT

In a method for operating a quantum computing system and a quantum computing system, the method for operating a quantum computing system may include: generating, by the QPU, a probability distribution of a quantum state by executing a quantum circuit; outputting, by the QPU, a measurement result of the quantum state as classical data; determining, by the classical processor, an information entropy for the probability distribution of the quantum state based on the classical data; determining, by the classical processor, the number of measurement shots of the QPU according to the information entropy; delivering, by the classical processor, the determined number of measurement shots to the QPU; and iteratively measuring, by the QPU, the quantum circuit with the determined number of measurement shots.

### CROSS-REFERENCE TO RELATED APPLICATION

The present application claims priority to Korean Patent Application No. 10-2024-0125804 filed on Sep. 13, 2024, the entire contents of which is incorporated herein for all purposes by this reference.

### BACKGROUND OF THE PRESENT DISCLOSURE

### Field of the Present Disclosure

The present disclosure relates to a method for operating a quantum computing system and a quantum computing system.

### DESCRIPTION OF RELATED ART

In recent years, multiple theoretical studies have been raised that a quantum computing algorithm will be able to solve a problem with lower calculation complexity than an existing method using a classical computer in various fields such as computational chemistry and optimization problems. A variational quantum algorithm (VQA) is a representative quantum computing algorithm, and an application of the VQA is made in calculation of bottom state energy and a combination optimization problem of molecules.

The VQA can operate through multiple iteration processes similar to a machine learning model training process. In each iteration or epoch, a probability distribution of a quantum state is measured, and a VQA parameter is updated based on the measurement result, and the VQA can operate by a mode of calculating a minimum value of an expectation value (e.g., molecular energy or optimization cost). The probability distribution of the quantum state may be obtained through iterative measurement (shot) by a quantum processing unit (QPU), measured data may be processed by the classical computer, and the result may be used for updating the VQA parameter.

Generally, a VQA performing process is optimized by a mode of fixing the number of shots of the QPU to a maximum value set in the QPU or a default value, and reducing the number of iteration times by improving a performance of a classical optimizer used for updating the VQA parameter to obtain the probability distribution of the quantum state. This allows the QPU to perform measurements of a fixed number of times regardless of an optimal number of shots required for measuring the probability distribution of the quantum state in each iteration, which can cause inefficient usage of a quantum computation processing resource. That is, when the probability distribution is sufficiently converged, unnecessary many shots are performed, and on the contrary, a reliable result may not be obtained due to the number of insufficient shots.

As a result, a plan to dynamically optimize the number of measurement shots of the QPU in the VQA performing process, and thereby reduce a driving time of a quantum simulation is required to increase the efficiency of the VQA and expand a simulation scale in a noisy intermediate-scale quantum (NISQ) quantum computer hardware and the quantum simulator.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method for operating a quantum computing system and a quantum computing system which dynamically optimize the number of measurement shots of a quantum processing unit (QPU) regardless of the type of classical optimizer to dynamically optimize the number of measurement shots of the QPU required for performing a variational quantum algorithm (VQA).

An exemplary embodiment of the present disclosure provides a method for operating a quantum computing system, which dynamically optimizes the number of measurement shots of a quantum processing unit (QPU) when a variational quantum algorithm (VQA) is executed in a quantum computing system including the QPU and a classical processor, which may include: generating, by the QPU, a probability distribution of a quantum state by executing a quantum circuit; outputting, by the QPU, a measurement result of the quantum state as classical data; calculating, by the classical processor, an information entropy for the probability distribution of the quantum state based on the classical data; determining, by the classical processor, the number of measurement shots of the QPU according to the information entropy; delivering, by the classical processor, the determined number of measurement shots to the QPU; and iteratively measuring, by the QPU, the quantum circuit with the determined number of measurement shots.

In some exemplary embodiments of the present disclosure, the determining of the number of measurement shots of the QPU may include determining, by the classical processor, the number of measurement shots of the QPU so that as a value of the information entropy becomes larger, the number of measurement shots becomes larger.

In some exemplary embodiments of the present disclosure, the determining of the number of measurement shots of the QPU may include determining, by the classical processor, the number of measurement shots of the QPU so that as the value of the information entropy becomes smaller, the number of measurement shots becomes smaller.

In some exemplary embodiments of the present disclosure, the determining of the information entropy may include determining, by the classical processor, a Shannon entropy for the probability distribution of the quantum state.

In some exemplary embodiments of the present disclosure, the Shannon entropy H may be determined according to Equation 1 below:

$$H = - {\sum }_{j} P ( {A}_{j} ) {log}_{2} P ( {A}_{j} ) \qquad ( Equation 1 )$$

Where P(Aⱼ) represents a probability of a specific measurement result. The j is a natural number.

In some exemplary embodiments of the present disclosure, the number of measurement shots, N may be determined according to Equation 2 below.

$$N = k \times 1 {0}^{log ( 2 ) \times H} \qquad ( Equation 2 )$$

Where k represents a predetermined constant.

In some exemplary embodiments of the present disclosure, the determining of the number of measurement shots of the QPU may further include determining, by the classical processor, when the determined number of measurement shots exceeds a predetermined upperlimit value, the determined number of measurement shots as the upperlimit value.

In some exemplary embodiments of the present disclosure, the determined number of measurement shots may be the dynamically determined number of measurement shots required at a next iteration based on the information entropy determined from the probability distribution of the quantum state at the previous iteration in each iteration of the VQA.

Another exemplary embodiment of the present disclosure provides a quantum computing system including: a quantum processing unit (QPU); and a classical processor, in which a variational quantum algorithm (VQA) may be executed, the QPU generates a probability distribution of a quantum state by executing a quantum circuit, and outputs a measurement result of the quantum state as classical data, the classical processor is configured to determine an information entropy for the probability distribution of the quantum state based on the classical data, determines the number of measurement shots of the QPU according to the information entropy, and delivers the determined number of measurement shots to the QPU, and the QPU iteratively measures the quantum circuit with the determined number of measurement shots.

In some exemplary embodiments of the present disclosure, the classical processor is configured to determine the number of measurement shots of the QPU so that as a value of the information entropy is larger, the number of measurement shots becomes larger.

In some exemplary embodiments of the present disclosure, the classical processor is configured to determine the number of measurement shots of the QPU so that as the value of the information entropy is smaller, the number of measurement shots becomes smaller.

In some exemplary embodiments of the present disclosure, the classical processor is configured to determine a Shannon entropy for the probability distribution of the quantum state.

In some exemplary embodiments of the present disclosure, the Shannon entropy H may be determined according to Equation 1 below.

$$H = - {\sum }_{j} P ( {A}_{j} ) {log}_{2} P ( {A}_{j} ) \qquad ( Equation 1 )$$

Where P(Aⱼ) represents a probability of a specific measurement result. The j is a natural number.

In some exemplary embodiments of the present disclosure, the number of measurement shots, N may be determined according to Equation 2 below.

$$N = k \times 1 {0}^{log ( 2 ) \times H} \qquad ( Equation 2 )$$

Where k represents a predetermined constant.

In some exemplary embodiments of the present disclosure, the classical processor may determine, when the determined number of measurement shots exceeds a predetermined upperlimit value, the determined number of measurement shots as the upperlimit value.

In some exemplary embodiments of the present disclosure, the determined number of measurement shots may be the dynamically determined number of measurement shots required at the next iteration based on the information entropy determined from the probability distribution of the quantum state at the previous iteration in each iteration of the VQA.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram for describing a quantum computing system according to an exemplary embodiment of the present disclosure.

FIG. 2 is a diagram for describing a method for operating a quantum computing system according to an exemplary embodiment of the present disclosure.

FIG. 3, FIG. 4, and FIG. 5 are diagrams for describing an advantageous effect for the method for operating a quantum computing system and a quantum computing system according to exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Exemplary embodiments of the present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various elements, but the elements are not limited by the terms. The terms are used only to discriminate one element from another element.

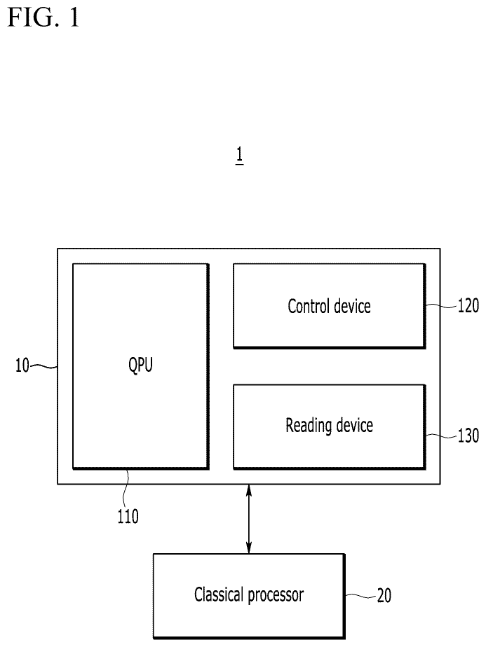

FIG. 1 is a diagram for describing a quantum computing system according to an exemplary embodiment of the present disclosure.

Referring to FIG. 1, the quantum computing system 1 may include quantum hardware 10 which communicates with one or more classical processors 20. The classical processor 20 may be configured to execute computer-readable instructions stored in one or more memory devices to perform any operation among operations described in an exemplary embodiment of the present disclosure. The quantum hardware 10 may include components for performing quantum calculation. For example, the quantum hardware 10 may include a quantum processing unit (QPU) 110, a control device 120, and a reading device 130 (e.g., a reading resonator). The quantum hardware 10 may further include a component such as a qubit register.

Quantum circuits may be applied to the qubit register through a plurality of control lines connected to the control device 120. The control device 120 which operates on the qubit register may be used to implement a quantum circuit including various quantum gates. The control device 120 may operate on the quantum hardware 10 through one or more control parameters.

The reading device 130 may perform quantum measurement, and transmit a measurement result to the classical processor 20. Meanwhile, the quantum circuit 10 may receive data specifying a physical control qubit parameter value from the classical processor 20. The quantum circuit 10 may update operations of the control device 120 and the reading device 130 by use of the received physical control qubit parameter value.

A variational quantum algorithm (VQA) may solve an optimization problem with lower complexity compared to the existing classical computing algorithm, but has a problem in that time and cost required to perform the algorithm are large due to a limit of the QPU. Upon simulating a quantum circuit forming the VQA, sufficiently many iteration measurements (shots) in the QPU are required to form the probability distribution of the quantum state. The quantum computing system 1 according to the exemplary embodiment of the present disclosure may optimize a VQA performing process by dynamically determining the number of measurement shots of the QPU by referring to an information entropy of a quantum state distribution output in a previous epoch in an iteration step of the VQA. The total number of shots required for VQA simulation may be optimized by a mode of determining the information entropy according to the generated probability distribution of the quantum state, and adjusting the number of measurement shots according to an entropy size, and increasing the number of shots when an entropy is large and decreasing the number of shots when the entropy is small. Through this, the number of circuit measurement times required for the simulation may be reduced by approximately 60% while maintaining cost function calculation accuracy of the VQA.

In the quantum computing system 1, the variational quantum algorithm (VQA) may be executed, and the QPU 110 may be configured to generate the probability distribution of the quantum state by executing the quantum circuit, and output a measurement result of the quantum state as classical data. The classical processor 20 may be configured to determine an information entropy for the probability distribution of the quantum state based on the classical data, and determine the number of measurement shots of the QPU 110 according to the information entropy, and deliver the determined number of measurement shots to the QPU 110. The QPU 110 may iteratively measure the quantum circuit with the determined number of measurement shots.

The classical processor 20 may be configured to determine the number of measurement shots of the QPU so that as a value of the information entropy becomes larger, the number of measurement shots becomes larger. Meanwhile, the classical processor 20 may be configured to determine the number of measurement shots of the QPU so that as the value of the information entropy becomes smaller, the number of measurement shots becomes smaller.

The determined number of measurement shots may be the dynamically determined number of measurement shots required at next iteration based on the information entropy determined from the probability distribution of the quantum state at the previous iteration in each iteration of the VQA.

In some exemplary embodiments of the present disclosure, the classical processor 20 may be configured to determine a Shannon entropy for the probability distribution of the quantum state. The Shannon entropy H may be determined according to Equation 1 below.

$$H = - {\sum }_{j} P ( {A}_{j} ) {log}_{2} P ( {A}_{j} ) \qquad ( Equation 1 )$$

Where P(Aⱼ) represents a probability of a specific measurement result. The j is the natural number.

In the instant case, the number of measurement shots, N may be determined according to Equation 2 below.

$$N = k \times 1 {0}^{log ( 2 ) \times H} \qquad ( Equation 2 )$$

Where k represents a predetermined constant.

In some exemplary embodiments of the present disclosure, the classical processor 20 may be configured to determine the determined number of measurement shots as an upperlimit value when the determined number of measurement shots exceeds a predetermined upperlimit value.

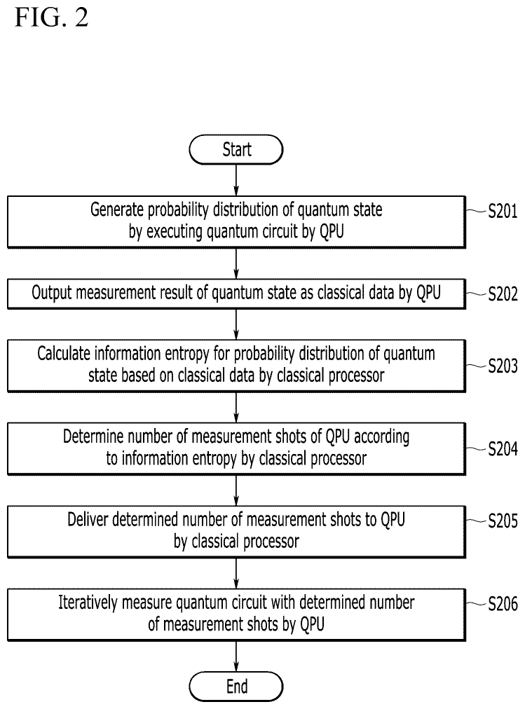

FIG. 2 is a diagram for describing a method for operating a quantum computing system according to an exemplary embodiment of the present disclosure.

Referring to FIG. 2, the method for operating a quantum computing system according to various exemplary embodiments of the present disclosure may include a step S201 of generating, by a QPU, a probability distribution of a quantum state by executing a quantum circuit, a step S202 of outputting, by the QPU, a measurement result of the quantum state as classical data, a step S203 of determining, by a classical processor, an information entropy for the probability distribution of the quantum state based on the classical data, a step S204 of determining, by the classical processor, the number of measurement shots of the QPU according to the information entropy, a step S205 of delivering, by the classical processor, the determined number of measurement shots to the QPU, and a step S206 of iteratively measuring, by the QPU, the quantum circuit with the determined number of measurement shots.

The detailed description described in the present specification may be referenced for more detailed contents for the method, so here, a redundant description will be omitted.

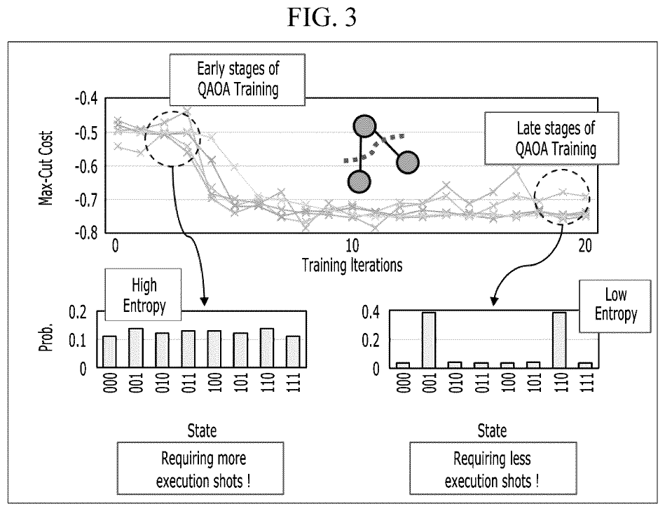

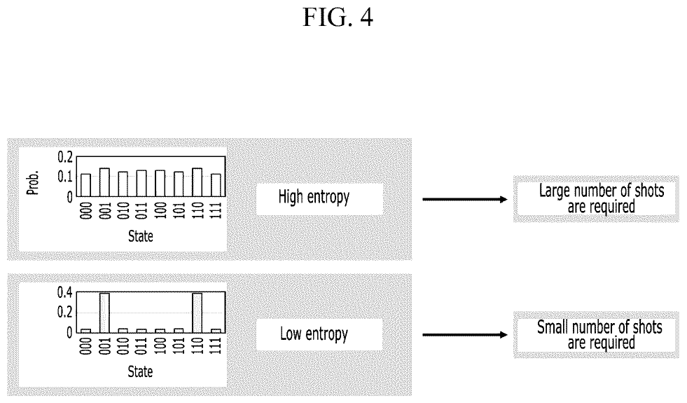

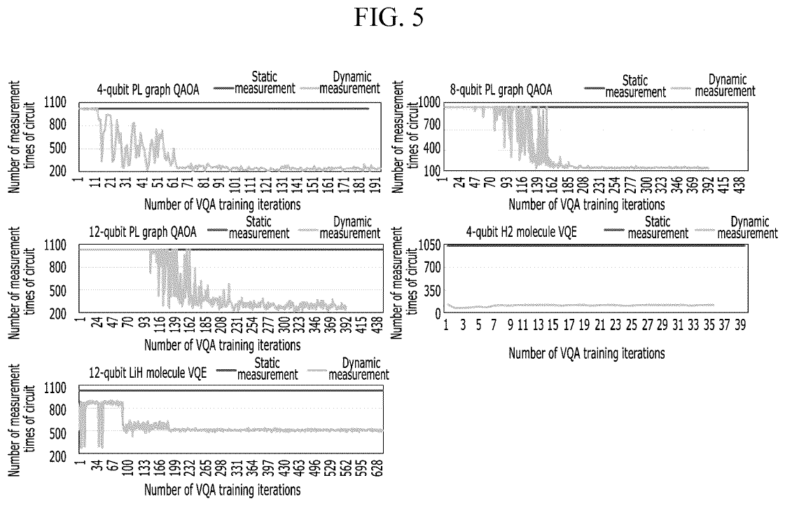

FIG. 3, FIG. 4, and FIG. 5 are diagrams for describing an advantageous effect for the method for operating a quantum computing system and a quantum computing system according to exemplary embodiments of the present disclosure.

Referring to FIG. 3, the information entropy is determined from an output (a quantum state distribution) of the quantum circuit forming the VQA to optimize the number of operation times of the QPU required for the variational quantum simulation. In several iteration processes in which the VQA is iteratively performed, the information entropy may be determined to analyze a quantitative feature of the output of the quantum circuit obtained in a current iteration step before a next iteration or epoch starts. According to the determined information entropy, the number of measurement shots of the QPU required to obtain an output result of the quantum circuit may be dynamically adjusted in the next iteration. Through this, a QPU usage may be optimized in the VQA performing process. Consequently, the QPU usage and the calculation time required for performing the VQA are significantly reduced compared to the method using the existing fixed number of shots.

Referring to FIG. 4, the number of measurement shots of the QPU may be one of the important factors for determining the execution time of the quantum algorithm. The dynamic optimization method of the number of measurement times of the QPU according to the exemplary embodiments of the present disclosure may enhance performance efficiency of the quantum algorithm regardless of the type of classical optimizer used in the VQA.

The probability distribution of the state represented by the quantum circuit may be quantified by determining the degree of diffusion as the information entropy. When the probability distribution of the quantum state output as a quantum circuit simulation result is uniformly diffused (that is, when the information entropy is high), the relatively larger number of shots is required to obtain quantum information including superposition and entanglement. On the other hand, when the probability distribution is concentrated on a specific point (that is, when the information entropy is low), superposition and entanglement quantum information may also be sufficiently obtained with the small number of measurement shots.

In some exemplary embodiments of the present disclosure, it may be assumed that a probability distribution of a trained result of an immediately previous iteration step and a probability distribution of a trained quantum circuit execution result of a current iteration step will not be significantly different in VQA training. Based thereon, an information entropy value of the probability distribution output in the previous iteration step is determined when performing the VQA to dynamically determine the number of measurement shots of the QPU required in the next iteration step.

In the present process, an upperlimit of the number of shots may be set to prevent the number of measurement shots from being excessively set. The QPU may perform the quantum circuit simulation with the number of shots specified in the previous iteration step, and determine the information entropy by referring to the probability distribution of the quantum state obtained as the result of the quantum circuit simulation. In a subsequent iteration step, the number of measurement shots of the QPU may be determined and the number of shots may be dynamically optimized by utilizing the information entropy value determined and stored in the previous iteration step.

In other words, in an initial iteration step, the output of the quantum circuit may be obtained with a predetermined number of shots of the QPU, and in a subsequent iteration step, the quantum circuit simulation result may be determined with the optimized number of shots based on the information entropy.

In some exemplary embodiments of the present disclosure, when the VQA is d, the output result of the quantum circuit may be obtained with the predetermined number of shots of the QPU in the initial iteration step. Alternatively, when an initial probability distribution state is already known, the number of shots suitable for an information entropy of the corresponding distribution may be applied.

In the subsequent iteration process, the information entropy for the probability distribution of the quantum circuit output in the previous step is determined to determine the number of measurement shots of the QPU required for the quantum circuit simulation in the next iteration. Furthermore, the upperlimit of the number of measurement shots may be set to prevent the excessive number of measurement times from being set.

In an entire VQA performing process, the number of shots of the QPU may be dynamically optimized based on the information entropy value determined in the previous iteration. Through this, after performing the VQA, the number of shots may be determined which is reduced compared to the existing fixed shot number mode, and QPU utilization efficiency may be analyzed.

Referring to FIG. 5, a result according to performing modes of static measurement and dynamic measurement for each of applications including a 4-qubit power law (PL) graph quantum approximate optimization algorithm (QAOA), an 8-qubit PL QAOA, a 12-qubit PL QAOA, a 4-qubit H₂ molecule VQE, and a 12-qubit LiH molecule VQE is shown.

TABLE 1

| | | | Number | | |
|---|---|---|---|---|---|
| | | | of | Con- | |
| | | Average | training | verged | Approxi- |
| | Performing | measure- | itera- | cost | mation |
| Applications | mode | ment shot | tions | value | ratio |
| 4-qubit PL | Static | 1024 | 185 | −2.68359 | 89% |
| QAOA | measurement | | | | |
| | Dynamic | 370.3 | 193 | −2.63867 | 88% |
| | measurement | | | | |
| 8-qubit PL | Static | 1024 | 442 | −6.77344 | 97% |
| QAOA | measurement | | | | |
| | Dynamic | 431.4 | 385 | −6.79688 | 97% |
| | measurement | | | | |
| 12-qubit PL | Static | 1024 | 450 | −9.98438 | 91% |
| QAOA | measurement | | | | |
| | Dynamic | 565 | 395 | −10.2402 | 93% |
| | measurement | | | | |
| 4-qubit H2 | Static | 1024 | 40 | −1.84065 | 99% |
| VQE | measurement | | | | |
| | Dynamic | 137.7 | 37 | −1.84273 | 99% |
| | measurement | | | | |
| 12-qubit | Static | 1024 | 659 | −8.84294 | 99% |
| LiH VQE | measurement | | | | |
| | Dynamic | 570.3 | 658 | −8.87282 | 100% |
| | measurement | | | | |
| Geometric | Static | 1024.0 | 249.7 | −4.9 | 95% |
| average | measurement | | | | |
| | Dynamic | 371.6 | 234.9 | −5.0 | 95% |
| | measurement | | | | |

| | | | | |
|---|---|---|---|---|
| Improvement rate | 60.2% | 6% | 0% | 0% |

The method according to exemplary embodiments of the present disclosure is applicable to all VQA applications required for updating a gate of a parameterized quantum circuit. Here, representative QAOA (quantum approximate optimization algorithm for solving a max-cut problem) and variational quantum eigensolver (VQE) are used.

In an experiment, a quantum circuit simulator of Qiskit-aer version 0.14.1 was used, and a code was modified to apply a method for dynamically optimizing the number of measurement times provided in the corresponding simulator (https://github.com/Qiskit/qiskit-aer). A total VQA training time was measured with a Python code, and a simulation time was performed in an AMD EPYC™ Model 7543 processor.

In the initial iteration step, the output result of the quantum circuit may be obtained with the predetermined number of shots of the QPU, and when an initial probability distribution may be known in advance, the information entropy of the corresponding distribution may be used. For example, in the QAOA max-cut problem, an initial distribution has a maximum entropy, and the initial distribution has a minimum entropy 1 in determining bottom state energy of the molecule through the VQE. The number of measurement shots in the next iteration step is dynamically determined by use of an information entropy H of the probability distribution determined in the immediately previous iteration step, and the number of shots is determined by the following equation.

The number of measurement shots=K×2^{H}

An upperlimit of the number of measurement shots is set to 1024, and when the determined value exceeds 1024, the number of measurements shots is executed with 1024. It is assumed that the number of static measurement times is 1024.

The K value may be appropriately set according to the VQA application. In the exemplary embodiment of the present disclosure, in the case of QAOA, K=64 is set, and in the case of the VQE, K=8 is set. In the case of the QAOA, the max-cut problem is solved by use of 4, 8, and 12-qubit scale power law (PL) model graphs. The PL graph is generated in a form in which an edge is concentrated on a single hub node. In the case of the VQE, bottom state energies of H₂ (hydrogen molecule) and LiH (lithium hydride) are determined, and as a VQE circuit ansatz, unitary coupled-cluster single and double (UCCSD) is used.

The number of training iterations is determined as a time point when a Qiskit-aer simulator satisfies a convergence condition of the cost function and is thus automatically terminated. The approximation ratio represents a ratio of a final cost of the VQA application output by the simulator and an actual known solution. In the QAOA, an actual solution value of a PL graph having n nodes is (n−1), and in the VQE, an electron bottom state energy (Hartree) of the corresponding molecule determined by a classical solver is a solution. A COBYLA optimizer was used to optimize the VQA application.

As may be seen in FIG. 5 and Table 1, the number of measurement shots of the QPU required for performing the VQA may be reduced compared to the existing static method (1024 times) by average 60.2% without increasing the number of training iteration steps while maintaining the accuracy (approximation ratio) of the VQA solution. When this is applied in an actual QPU device, it is expected that the performing time will be reduced due to a decrease in the number of measurement shots.

In a QAOA example, it is analyzed that the information entropy is high at the early stage of the training, but the probability is concentrated on a ground truth state and the information entropy is lowered toward the middle stage and the last stage of the training, and as a result, the number of measurement times is reduced. In the case of a VQE example, it may be seen that since an orbital space in which electrons will exist is limited on a bottom state, a low information entropy is maintained from the early stage to the last stage of the training, and the number of measurement times is reduced overall.

Through this, it may be seen that the number of measurement shots of 1024 times generally used at present is excessive in the VQA example. In the future, it is expected that in a VQA that targets a hug-scale graph problem or a high molecule, the number of required measurement times will increase as the information entropy increases, and the present method may be used as a useful indicator for presenting the appropriate number of measurement times when executing a large-scale VQA.

According to the exemplary embodiments described up to now, in an exemplary embodiment of the present disclosure, the number of measurement shots by the quantum processing unit (QPU) is dynamically adjusted and optimized by determining an information entropy size of a quantum state probability distribution in each iteration step of the VQA to reduce a cost (i.e., the number of measurement times of the QPU) required when performing the variational quantum algorithm (VQA), and furthermore, advance a utilization time of quantum computing technology in a mobility related virtual material simulation. Furthermore, by specifying the minimum number of quantum measurement times required for implementing a quantum circuit, the average number of measurement times required for performing the simulation may be reduced by approximately 60% or more while maintaining computation accuracy compared to the existing quantum computing algorithm. Since an execution time of an actual QPU is in proportion to the number of measurement times, reduction of a VQA performing time may be expected when the exemplary embodiments are applied to the actual QPU.

expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for operating a quantum computing system, which dynamically optimizes a number of measurement shots of a quantum processing unit (QPU) when a variational quantum algorithm (VQA) is executed in the quantum computing system including the QPU and a classical processor, the method comprising:
generating, by the QPU, a probability distribution of a quantum state by executing a quantum circuit;
outputting, by the QPU, a measurement result of the quantum state as classical data;
determining, by the classical processor, an information entropy for the probability distribution of the quantum state based on the classical data;
determining, by the classical processor, the number of measurement shots of the QPU according to the information entropy;
delivering, by the classical processor, the determined number of measurement shots to the QPU; and
iteratively measuring, by the QPU, the quantum circuit with the determined number of measurement shots.

2. The method of claim 1, wherein the determining of the number of measurement shots of the QPU includes:
determining, by the classical processor, the number of measurement shots of the QPU so that as a value of the information entropy becomes larger, the number of measurement shots becomes larger.

3. The method of claim 1, wherein the determining of the number of measurement shots of the QPU includes:
determining, by the classical processor, the number of measurement shots of the QPU so that as the value of the information entropy becomes smaller, the number of measurement shots becomes smaller.

4. The method of claim 1, wherein the determining of the information entropy includes:
determining, by the classical processor, a Shannon entropy for the probability distribution of the quantum state.

5. The method of claim 4, wherein the Shannon entropy H is determined according to Equation 1 below,
$$H = - {\sum }_{j} P ( {A}_{j} ) {log}_{2} P ( {A}_{j} ) \qquad ( Equation 1 )$$
where P(Aⱼ) represents a probability of a specific measurement result and the j is a natural number.

6. The method of claim 5, wherein the number of measurement shots, N is determined according to Equation 2 below,
$$N = k \times 1 {0}^{log ( 2 ) \times H} \qquad ( Equation 2 )$$
where k represents a predetermined constant.

7. The method of claim 1, wherein the determining of the number of measurement shots of the QPU further includes:
when the determined number of measurement shots exceeds a predetermined upperlimit value, determining, by the classical processor, the determined number of measurement shots as the upperlimit value.

8. The method of claim 1, wherein the determined number of measurement shots is the dynamically determined number of measurement shots required at next iteration based on the information entropy determined from the probability distribution of the quantum state at previous iteration in each iteration of the VQA.

9. A quantum computing system comprising:
a quantum processing unit (QPU); and
a classical processor,
wherein a variational quantum algorithm (VQA) is executed,
wherein the QPU generates a probability distribution of a quantum state by executing a quantum circuit, and outputs a measurement result of the quantum state as classical data,
wherein the classical processor is configured to determine an information entropy for the probability distribution of the quantum state based on the classical data, to determine a number of measurement shots of the QPU according to the information entropy, and to deliver the determined number of measurement shots to the QPU, and
wherein the QPU iteratively measures the quantum circuit with the determined number of measurement shots.

10. The quantum computing system of claim 9, wherein the classical processor is further configured to determine the number of measurement shots of the QPU so that as a value of the information entropy becomes larger, the number of measurement shots becomes larger.

11. The quantum computing system of claim 9, wherein the classical processor is further configured to determine the number of measurement shots of the QPU so that as the value of the information entropy becomes smaller, the number of measurement shots becomes smaller.

12. The quantum computing system of claim 9, wherein the classical processor is configured to determine a Shannon entropy for the probability distribution of the quantum state.

13. The quantum computing system of claim 12, wherein the Shannon entropy H is determined according to Equation 1 below,
$$H = - {\sum }_{j} P ( {A}_{j} ) {log}_{2} P ( {A}_{j} ) \qquad ( Equation 1 )$$
where P(Aⱼ) represents a probability of a specific measurement result and the j is a natural number.

14. The quantum computing system of claim 13, wherein the number of measurement shots, N is determined according to Equation 2 below,
$$N = k \times 1 {0}^{log ( 2 ) \times H} \qquad ( Equation 2 )$$
where k represents a predetermined constant.

15. The quantum computing system of claim 9, wherein when the determined number of measurement shots exceeds a predetermined upperlimit value, the classical processor is further configured to determine the determined number of measurement shots as the upperlimit value.

16. The quantum computing system of claim 9, wherein the determined number of measurement shots is a dynamically determined number of measurement shots required at next iteration based on the information entropy determined from the probability distribution of the quantum state at previous iteration in each iteration of the VQA.
